(19) United States
(12) Patent Application Publication
(10) Pub. No.: US 2005/0154928 A1
(43) Pub. Date: Jul. 14, 2005

(54) Remote power-on functionality in a partitioned environment

(75) Inventors: David Anthony Larson, Rochester, MN (US); Kyle Alan Lucke, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/753,518

(22) Filed: Jan. 8, 2004

(51) Int. Cl. G06F 1/26

(52) U.S. Cl. 713/300

(57) ABSTRACT

A method, apparatus, system, and signal-bearing medium that in an embodiment detect that a power-on packet has been received and power on a partition in a logically-partitioned computer in response to the power-on packet. In various embodiments, the partition that is powered on is determined based on the network adapter that received the power-on packet or based on an address in the power-on packet. The network adapter may be a physical adapter or a virtual adapter.

### FIELD

An embodiment of the invention generally relates to computers. In particular, an embodiment of the invention generally relates to a remote power on function in a logically partitioned computer.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. Computer technology continues to advance at a rapid pace, with significant developments being made in both software and in the underlying hardware upon which the software executes. One significant advance in computer technology is the development of parallel processing, i.e., the performance of multiple tasks in parallel.

A number of computer software and hardware technologies have been developed to facilitate increased parallel processing. From a hardware standpoint, computers increasingly rely on multiple microprocessors to provide increased workload capacity. Furthermore, some microprocessors have been developed that support the ability to execute multiple threads in parallel, effectively providing many of the same performance gains attainable through the use of multiple microprocessors. From a software standpoint, multithreaded operating systems and kernels have been developed, which permit computer programs to concurrently execute in multiple threads so that multiple tasks can essentially be performed at the same time.

In addition, some computers implement the concept of logical partitioning, where a single physical computer is permitted to operate essentially like multiple and independent virtual computers, referred to as logical partitions, with the various resources in the physical computer (e.g., processors, memory, and input/output devices) allocated among the various logical partitions. Each logical partition executes a separate operating system, and from the perspective of users and of the software applications executing on the logical partition, operates as a fully independent computer.

Another significant improvement in computer systems is a remote power on function, one implementation of which is known as Wake on LAN (Local Area Network) (WOL) technology. WOL is the ability to power on remote computers through the use of special network packets. WOL is based on the principle that when the PC shuts down, the network interface card or LAN adapter still receives power and keeps listening on the network for a special WOL packet to arrive. When the WOL packet is received, the network interface card sends a signal to the power supply, which then supplies electrical power to the rest of the computer. Unfortunately, WOL only works with network cards and motherboards that are WOL compliant and is only capable of powering on the entire computer through the power supply. Thus, WOL does not work well in a logically partitioned computer because WOL does not distinguish between the multiple virtual computers operating as logical partitions within the single physical computer.

Without a way to provide Wake on LAN functioning in a logically partitioned environment, users of logically partitioned computers will be unable to enjoy the advantages of remote power on operations. Although the aforementioned problems have been described in the context of WOL, they apply to any remote power on operation, regardless of the type of network.

### SUMMARY

A method, apparatus, system, and signal-bearing medium are provided that in an embodiment detect that a power-on packet has been received and power on a partition in a logically-partitioned computer in response to the power-on packet. In various embodiments, the partition that is powered on is determined based on the network adapter that received the power-on packet or based on an address in the power-on packet. The network adapter may be a physical adapter or a virtual adapter.

### BRIEF DESCRIPTION OF THE DRAWINGS

FIG. 1 depicts a block diagram of an example system for implementing an embodiment of the invention.

FIG. 2 depicts a flowchart of example configuration processing for a network adapter, according to an embodiment of the invention.

FIG. 3 depicts a flowchart of example processing for a remote power-on function using one physical network adapter per partition, according to an embodiment of the invention.

FIG. 4 depicts a flowchart of example processing for a remote power-on function using a single physical network adapter for the entire computer, according to an embodiment of the invention.

FIG. 5 depicts a flowchart of example processing for a remote power-on function using a virtual network adapter per partition, according to an embodiment of the invention.

### DETAILED DESCRIPTION

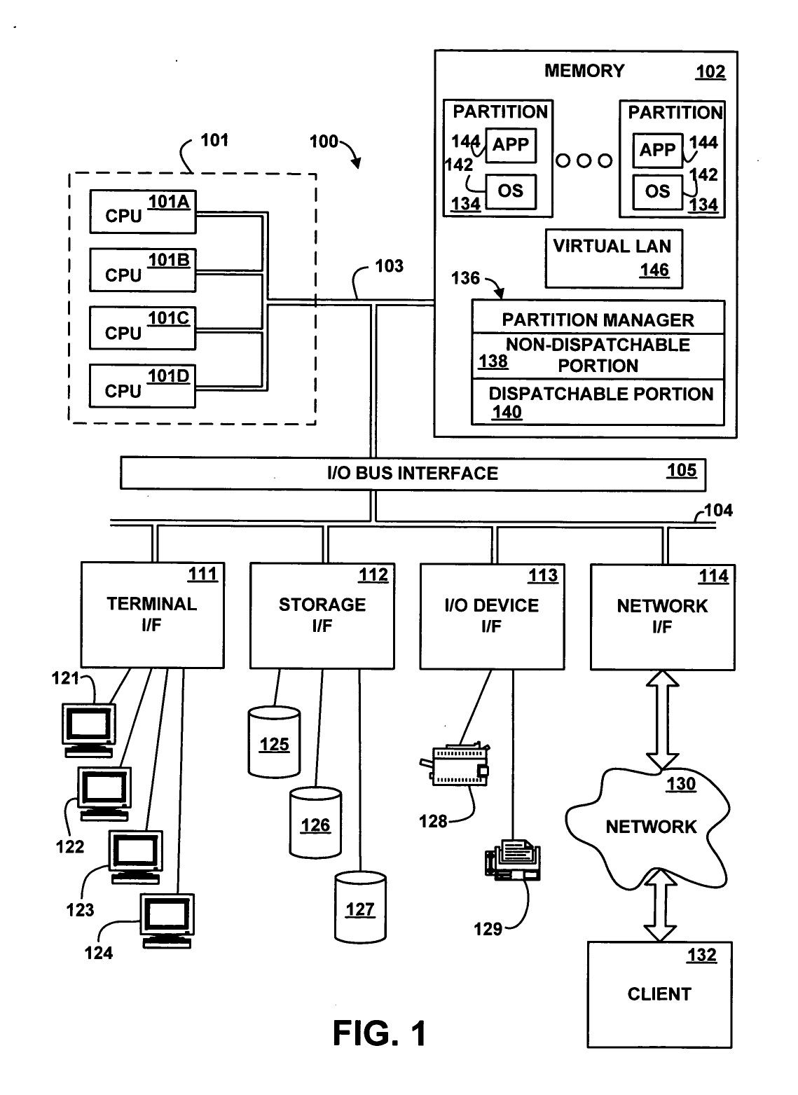

Referring to the Drawing, wherein like numbers denote like parts throughout the several views, FIG. 1 depicts a high-level block diagram representation of a computer system 100, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

Each processor 101 may be implemented as a single threaded processor, or as a multithreaded processor. For the most part, each hardware thread in a multithreaded processor is treated like an independent processor by the software resident in the computer 100. In this regard, for the purposes of this disclosure, a single threaded processor will be considered to incorporate a single hardware thread, i.e., a single independent unit of execution. It will be appreciated, however, that software-based multithreading or multitasking may be used in connection with both single threaded and multithreaded processors to further support the parallel performance of multiple tasks in the computer 100.

In addition, one or more of processors 101 may be implemented as a service processor, which is used to run specialized firmware code to manage system initial program loads (IPLs) and to monitor, diagnose and configure system hardware. Generally, the computer 100 will include one service processor and multiple system processors, which are used to execute the operating systems and applications resident in the computer 100, although other embodiments of the invention are not limited to this particular implementation. In some embodiments, a service processor may be coupled to the various other hardware components in the computer 100 in a manner other than through the bus 103.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. E.g., memory may exist in multiple levels of caches, and these caches may be further divided by function, so that one cache holds instructions while another holds non-instruction data, which is used by the processor 101. Memory may further be distributed and associated with different CPUs or sets of CPUs, as is known in any of various so-called non-uniform memory access (NUMA) computer architectures.

The memory 102 is illustrated as containing the primary software components and resources utilized in implementing a logically partitioned computing environment on the computer 100, including a plurality of logical partitions 134 managed by a partition manager or hypervisor 136. Any number of logical partitions 134 may be supported as is well known in the art, and the number of the logical partitions 134 resident at any time in the computer 100 may change dynamically as partitions are added or removed from the computer 100.

In the illustrated IBM eServer-based implementation of FIG. 1, the partition manager 136 is comprised of two layers of program code. But, in other embodiments, the partition manager 136 need not have multiple layers or may have any number of layers. The first layer, referred to herein as a non-dispatchable portion 138, is implemented within the firmware, or licensed internal code (LIC), of the computer 100, which is utilized to provide a low level interface to various hardware components while isolating higher layers, e.g., the operating systems, from the details of the hardware access. The firmware may also communicate with a service processor such as a service processor. The non-dispatchable portion 138 provides many of the low level partition management functions for the computer 100, e.g., page table management. The non-dispatchable portion 138 also has no concept of tasks, and is accessible principally via function calls from higher layers of software.

The second layer of program code in the partition manager 136 is referred to herein as a dispatchable portion 140. In contrast to the non-dispatchable portion 138, which has no concept of tasks, is run with relocation off, and is accessible via function calls from higher layers of software, the dispatchable portion 140 has the concept of tasks (like any operating system), and is run with relocation on. The dispatchable portion 140 typically executes in much the same manner as a partition, except that it is hidden from the user. The dispatchable portion 140 generally manages higher level partition management operations such as creating and deleting partitions, concurrent I/O maintenance, allocating processors, memory and other hardware resources to various the partitions 134.

Each logical partition 134 is typically statically and/or dynamically allocated a portion of the available resources in computer 100. For example, each logical partition 134 may be allocated one or more of the processors 101 and/or one or more hardware threads, as well as a portion of the available memory space. The logical partitions 134 can share specific hardware resources such as the processors 101, such that a given processor 101 is utilized by more than one logical partition. In the alternative, hardware resources can be allocated to only one logical partition 134 at a time.

Additional resources, e.g., mass storage, backup storage, user input, network connections, and the I/O adapters therefor, are typically allocated to one or more of the logical partitions 134 in a manner well known in the art. Resources may be allocated in a number of manners, e.g., on a bus-by-bus basis, or on a resource-by-resource basis, with multiple logical partitions sharing resources on the same bus. Some resources may even be allocated to multiple logical partitions at a time.

Each of the logical partitions 134 utilizes an operating system 142, which controls the primary operations of the logical partition 134 in the same manner as the operating system of a non-partitioned computer. For example, each operating system 142 may be implemented using the OS/400 operating system available from International Business Machines Corporation, but in other embodiments any appropriate operating system may be used, and some or all of the operating systems 142 may be the same or different from each other.

Each of the logical partition 134 executes in a separate, or independent, memory space, and thus each logical partition acts much the same as an independent, non-partitioned computer from the perspective of each user application 144 that executes in each such logical partition. As such, user applications typically do not require any special configuration for use in a partitioned environment.

Given the nature of logical partitions 134 as separate virtual computers, it may be desirable to support inter-partition communication to permit the logical partitions to communicate with one another as if the logical partitions were on separate physical machines. As such, in some implementations it may be desirable to support a virtual local area network (LAN) adapter 146 associated with the non-dispatchable portion 138 to permit the logical partitions 134 to communicate with one another via a networking protocol such as the Ethernet protocol. In another embodiment, the virtual network adapter 146 may bridge to a physical adapter, such as the network interface adapter 114. Other manners of supporting communication between partitions may also be supported consistent with embodiments of the invention.

It will be appreciated that other logically-partitioned environments may be utilized consistent with embodiments of the invention. For example, rather than utilizing a dispatchable portion 140 that is separate from any partition 134, the functionality of the dispatchable portion 140 may be incorporated into one or more logical partitions 134 in the alternative.

Although the partition manager 136, the virtual LAN adapter 146, and the partitions 134 are illustrated as being contained within the memory 102 in the computer system 100, in other embodiments some or all of them may be on different computer systems and may be accessed remotely, e.g., via the network 130. Further, the computer system 100 may use virtual addressing mechanisms that allow the programs of the computer system 100 to behave as if they only have access to a large, single storage entity instead of access to multiple, smaller storage entities. Thus, while the partition manager 136, the virtual LAN adapter 146, and the partitions 134 are illustrated as residing in the memory 102, these elements are not necessarily all completely contained in the same storage device at the same time.

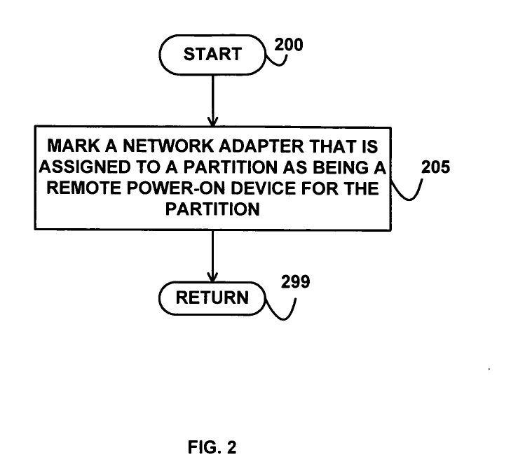

In an embodiment, the partition manager 136 includes instructions capable of executing on the processor 101 or statements capable of being interpreted by instructions executing on the processor 101 to perform the functions as further described below with reference to FIGS. 2, 3, 4, and 5. In another embodiment, the partition manager 136 may be implemented in microcode or firmware. In another embodiment, the partition manager 136 may be implemented in hardware via logic gates and/or other appropriate hardware techniques.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host).

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

Although the memory bus 103 is shown in FIG. 1 as a relatively simple, single bus structure providing a direct communication path among the processors 101, the main memory 102, and the I/O bus interface 105, in other embodiments the memory bus 103 may comprise multiple different buses or communication paths, which may be arranged in any of various forms, such as point-to-point links in hierarchical, star or web configurations, multiple hierarchical buses, or parallel and redundant paths. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user or mainframe computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

It should be understood that FIG. 1 is intended to depict the representative major components of the computer system 100 at a high level, that individual components may have greater complexity that represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The computer 100 is connected to the client 132 via the network 130. In an embodiment, the client 132 issues a remote power-on packet to the computer 100 via the network 130 in order to power on a selected partition 134 in the computer 100. In an embodiment, the remote power-on packet may be a Wake On LAN (WOL) packet, but in other embodiments any appropriate type of packet that requests a remote power-on may be used, and embodiments of the invention are not restricted to a particular network protocol and are not restricted to a LAN (Local Area Network). One or more of the partitions 134 may also issue a power-on packet to another of the partitions 134 via the virtual LAN adapter 146 in addition to or in lieu of the client 132.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 125, 126, or 127) or diskette; or
(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a flowchart of example configuration processing for a remote power-on function, according to an embodiment of the invention. In various embodiments, the processing of FIG. 2 may be performed for each network adapter in the computer 100 or only for selected or designated network adapters.

Control begins at block 200. Control then continues to block 205 where the partition manager 136 marks a network adapter, such as the network interface adapter 114 or the virtual network adapter 146, which is assigned to a partition 134 as being a remote power-on device for the partition 134. Control then continues to block 299 where the logic of FIG. 2 returns.

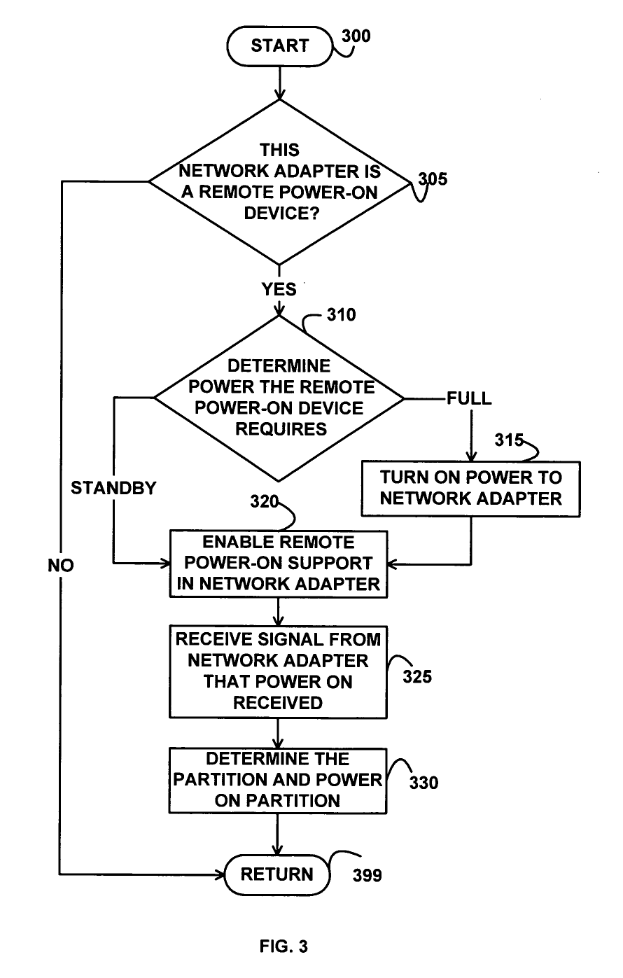

FIG. 3 depicts a flowchart of example processing for a remote power-on function using a physical network adapter per partition, according to an embodiment of the invention. The processing illustrated in FIG. 3 is typically performed when the computer 100 is powered on, but in other embodiments the processing of FIG. 3 may be performed at any appropriate time. In various embodiments, the processing of FIG. 3 may be performed once for each network interface adapter 114 or may be performed only for a particular, selected, or designated network interface adapter(s) 114.

Control begins at block 300. Control then continues to block 305 where the partition manager 136 determines whether the current network adapter, such as the network interface 114, is marked as a remote power-on device (network adapters were marked as remote power-on devices as previously described above with reference to FIG. 2). If the determination at block 305 is true, then this network adapter is a remote power-on device, so control continues from block 305 to block 310 where the partition manager 136 determines the type of power that the remote power-on device requires.

If the remote power-on device requires full power, then control continues from block 310 to block 315 where the partition manager 136 turns on power to the network adapter. Control then continues to block 320 where the partition manager 136 enables or configures remote power-on support in the network adapter. Control then continues to block 325 where the partition manager 136 waits for and receives a signal from the network adapter that a power-on packet was received from the client 132 via the network 130. Control then continues to block 330 where the partition manager 136 determines the partition 134 that is associated with the network adapter and powers on that partition 134. In an embodiment, powering on the partition 134 includes at least starting or invoking the operating system 142, which is associated with the partition 134. Control then continues to block 399 where the logic of FIG. 3 returns.

If the remote power-on device requires standby power, then control continues from block 310 to block 320, as previously described above.

If the current network adapter is not a remote power-on device, then control continues from block 305 to block 399 where the logic of FIG. 3 returns.

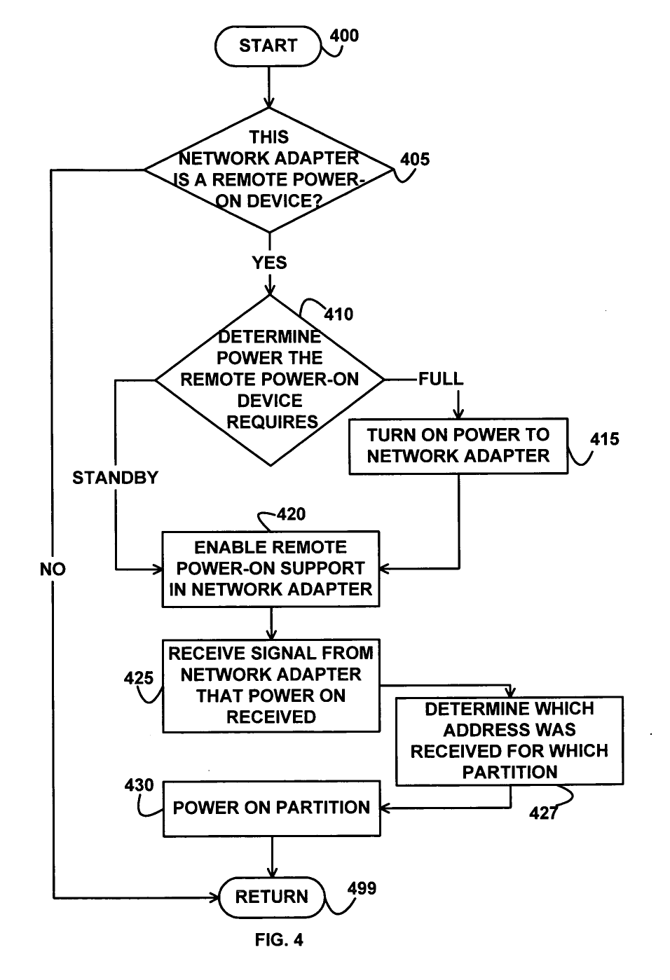

FIG. 4 depicts a flowchart of example processing for a remote power-on function using a single physical network adapter for the entire computer 100, according to an embodiment of the invention. The processing illustrated in FIG. 4 is typically performed when the computer 100 is powered on, but in other embodiments the processing of FIG. 4 may be performed at any appropriate time. In various embodiments, the processing of FIG. 4 may be performed once for each network interface 114 or may be performed only for a particular, selected, or designated network interface(s) 114.

Control begins at block 400. Control then continues to block 405 where the partition manager 136 determines whether the current network adapter, such as the network interface 114, is a remote power-on device for the entire computer 100. If the determination at block 405 is true, then this network adapter is a remote power-on device, so control continues from block 405 to block 410 where the partition manager 136 determines the type of power that the remote power-on device requires.

If the remote power-on device requires full power, then control continues from block 410 to block 415 where the partition manager 136 turns on power to the network adapter. Control then continues to block 420 where the partition manager 136 enables or configures remote power-on support in the network adapter. Control then continues to block 425 where the partition manager 136 waits for and receives a signal from the network adapter that a power-on packet was received from the client 132 via the network 130.

Control then continues to block 427 where the partition manager 136 determines the partition 134 that is associated with the MAC (Media Access Control) address that is included in the power-on packet that the network adapter received. In another embodiment any type of address may be included in the power-on packet and any type of networking protocol may be used.

Control then continues to block 430 where the partition manager 136 powers on the partition 134 that is associated with the MAC address that was received in the packet via the network adapter. In an embodiment, powering on the partition 134 includes at least starting or invoking the operating system 142, which is associated with the partition 134. Control then continues to block 499 where the logic of FIG. 4 returns.

If the remote power-on device requires standby power, then control continues from block 410 to block 420, as previously described above.

If the current network adapter is not a remote power-on device, then control continues from block 405 to block 499 where the logic of FIG. 4 returns.

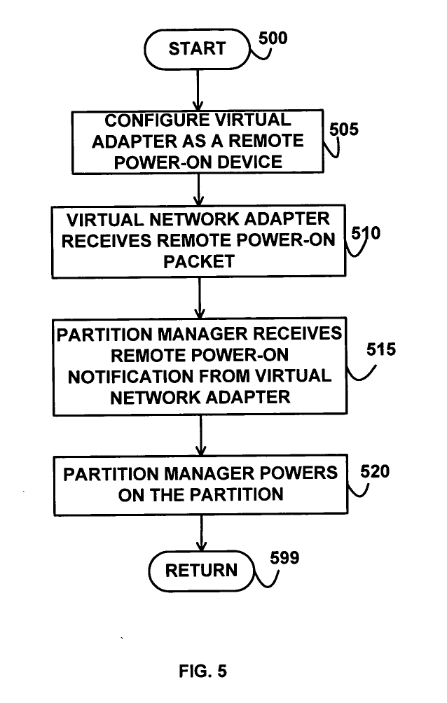

FIG. 5 depicts a flowchart of example processing for a remote power-on function using the virtual network adapter 146, where virtual network adapters may be allocated on a per-partition basis, according to an embodiment of the invention. Control begins at block 500. Control then continues to block 505 where the partition manager 136 configures the virtual network adapter 146 as a remote power-on device that is associated with a particular partition 134. Control then continues to block 510 where the virtual network adapter 146 receives a remote power-on packet from one of the partitions 134 or from the client 132 via the network 130 and the physical network adapter 114. Control then continues to block 515 where the partition manager 136 receives a notification from the virtual network adapter 146 that the remote power-on packet was received. Control then continues to block 520 where the partition manager 136 determines the partition 134 that is associated with the virtual network adapter 146 and powers on that determined partition 134. In an embodiment, powering on the partition 134 includes at least starting or invoking the operating system 142, which is associated with the partition 134. Control then continues to block 599 where the logic of FIG. 5 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

1. A method comprising:
detecting a power-on packet; and
powering on a partition in a logically-partitioned computer in response to the power-on packet.

2. The method of claim 1, further comprising:
determining the partition based on a physical network adapter that receives the power-on packet.

3. The method of claim 1, further comprising:
determining the partition based on an address in the power-on packet.

4. The method of claim 1, further comprising:
determining the partition based on a virtual adapter that receives the remote power-on packet.

5. The method of claim 2, further comprising:
determining a type of power required by the physical network adapter.

6. An apparatus comprising:
means for configuring remote power-on support in a network adapter;
means for detecting that the network adapter received a power-on packet; and
means for powering on a partition in a logically-partitioned computer in response to the power-on packet.

7. The apparatus of claim 6, further comprising:
means for determining the partition based on the network adapter.

8. The apparatus of claim 6, further comprising:
means for determining the partition based on an address in the power-on packet.

9. The apparatus of claim 6, wherein the network adapter comprises a physical adapter.

10. The apparatus of claim 6, further comprising:
means for determining a type of power required by the network adapter.

11. A signal-bearing medium encoded with instructions, wherein the instructions when executed comprise:
configuring remote power-on support in a network adapter;
determining a type of power required by the network adapter;
detecting that the network adapter received a power-on packet; and
powering on a partition in a logically-partitioned computer in response to the power-on packet.

12. The signal-bearing medium of claim 11, further comprising:
determining the partition based on the network adapter that received the power-on packet.

13. The signal-bearing medium of claim 11, further comprising:
determining the partition based on an address in the power-on packet.

14. The signal-bearing medium of claim 11, further comprising:
turning on power to the network adapter if the power type is full power.

15. The signal-bearing medium of claim 11, wherein the powering on the partition further comprises:
starting an operating system associated with the partition.

16. A computer system having a plurality of logical partitions, the computer system comprising:
at least one processor; and
memory encoded with instructions, wherein the instructions when executed on the at least one processor comprise:
configuring remote power-on support in a network adapter if the network adapter supports a power-on packet,
determining a type of power required by the network adapter,
detecting that the network adapter received the power-on packet, and
powering on a first partition of the plurality of partitions in response to the power-on packet.

17. The computer system of claim 16, wherein the instructions further comprise:
determining the first partition based on the network adapter that received the power-on packet.

18. The computer system of claim 16, wherein the instructions further comprise:
determining the first partition based on an address in the power-on packet.

19. The computer system of claim 16, wherein the instructions further comprise:
turning on power to the network adapter if the type of power is full power.

20. The computer system of claim 16, wherein the powering on the first partition further comprises:
starting an operating system associated with the first partition.
